(19) United States
(12) Patent Application Publication
(10) Pub. No.: US 2022/0380628 A1
(43) Pub. Date: Dec. 1, 2022

(54) Methods, Articles and Adhesive Composition Comprising Unpolymerized Cyclic Olefin, Catalyst, and Adhesion Promoter Polymer

(71) Applicant: 3M INNOVATIVE PROPERTIES COMPANY, St. Paul, MN (US)

(72) Inventors: Binhong Lin, Woodbury, MN (US); Mario A. Perez, Burnsville, MN (US); Erik M. Townsend, South St. Paul, MN (US); Michael A. Kropp, Cottage Grove, MN (US); Nelson T. Rotto, Woodbury, MN (US); Kalc C. Vang, Oakdale, MN (US); Surender Maddela, Woodbury, MN (US); Lianzhou Chen, Woodbury, MN (US)

(21) Appl. No.: 17/633,266

(22) PCT Filed: Oct. 8, 2020
(86) PCT No.: PCT/IB2020/059476

§ 371 Date: Feb. 7, 2022

Related U.S. Application Data
(60) Provisional application No. 62/914,683, filed on Oct. 14, 2019.
(60) Provisional application No. 62/951,017, filed on Dec. 20, 2019.
(60) Provisional application No. 62/982,769, filed on Feb. 28, 2020.
(60) Provisional application No. 63/046,833, filed on Jul. 1, 2020.

(51) Int. Cl. C09J 4/06; C09J 145/00; C09J 11/08; C09J 5/00; H01M 10/613; H01M 10/625; H01M 10/653; B32B 7/12; B32B 27/34; B32B 37/12; B29C 65/48; B29C 65/00; B32B 37/18

(52) U.S. Cl. CPC C09J 4/06; C09J 145/00; C09J 11/08; C09J 5/00; H01M 10/613; H01M 10/625; H01M 10/653; B32B 7/12; B32B 27/34; B32B 37/12; B29C 65/48; B29C 66/7392; B32B 37/182; C09J 2423/00; C09J 2409/00; C09J 2475/00; C09J 2477/008; B29K 2077/00

(57) ABSTRACT

An adhesive composition is described comprising unpolymerized cyclic olefin, a ring opening metathesis polymerization (ROMP) catalyst or precatalyst thereof, and one or more adhesion promoter polymers. In one embodiment, the adhesion promoter is a polyolefin comprising maleic anhydride or silicon-containing moieties. In one embodiment, a combination of at least one polymeric polyisocyanate and at least one polyolefin comprising maleic anhydride or silicon-containing moieties provides a synergistic improvement. In another embodiment, a polymeric polyisocyanate adhesion promoter comprising oxygen atoms in the backbone has been found useful for bonding substrates such as polyamide, polyether ether ketone, or polyether imide. Also described are methods of bonding a substrate and articles, such as an electric battery cold plate assembly.

### SUMMARY

In one embodiment, an adhesive composition is described comprising unpolymerized cyclic olefin and a ring opening metathesis polymerization (ROMP) catalyst or precatalyst thereof. The adhesive composition further comprises one or more adhesion promoter polymers. In one embodiment, the adhesion promoter is a polyolefin comprising maleic anhydride or silicon-containing moieties. In some embodiments, a combination of at least one polymeric polyisocyanate and at least one polyolefin comprising maleic anhydride or silicon-containing moieties provide a synergistic improvement. In other embodiments, a polymeric polyisocyanate adhesion promoter comprising oxygen atoms in the backbone has been found useful for bonding substrates such as polyamide, polyether ether ketone, or polyether imide.

In another embodiment, a method of bonding a substrate is described comprising providing an adhesive composition as described herein, applying the adhesive composition to a substrate; and polymerizing the cyclic olefin by exposure to actinic radiation, heat, or a combination thereof.

In another embodiment, an article is described comprising a first substrate adhered to a second substrate with an adhesive composition as described herein. In some embodiments, the substrate is metal, such as steel, aluminum, or copper. In other embodiments, the substrate comprises polyamide, such as nylon polyether ether ketone, or polyether imide.

In one embodiment, the article is a cold plate assembly of an electric vehicle battery.

### BRIEF DESCRIPTION OF DRAWINGS

FIG. 1 is a cross-sectional side view of one embodiment of a cold plate assembly for an electric vehicle battery assembly;

FIG. 2 is a cross-sectional side view of another embodiment of a cold plate assembly for an electric vehicle battery assembly;

FIG. 3 is a cross-sectional side view of another embodiment of a cold plate assembly for an electric vehicle battery assembly.

### DETAILED DESCRIPTION

The adhesive compositions described herein comprise one or more unpolymerized cyclic olefins. The cyclic olefins are generally mono-unsaturated (i.e. mono-olefin) or poly-unsaturated (i.e. comprising two or more carbon-carbon double bonds or in other words alkene groups). The double bond or in other words ethylenic unsaturation is not part of a (meth)acrylate or vinyl ether group. The cyclic olefin may be mono- or poly-cyclic (i.e. comprising two or more cyclic groups). The cyclic olefin may generally be a strained or unstrained cyclic olefin, provided the cyclic olefin is able to participate in a ROMP reaction either individually or as part of a ROMP cyclic olefin composition.

The polymerizable adhesive composition comprise cyclic diene monomers, including for example 1,3-cyclopentadiene, 1,3-cyclohexadiene, 1,4-cyclohexadiene, 5-ethyl-1,3-cyclohexadiene, 1,3-cycloheptadiene, cyclohexadiene, 1,5-cyclooctadiene, 1,3-cyclooctadiene, norbornadiene, cyclohexenylnorbornene, including oligomers thereof such as dimers, trimers, tetramers, pentamers, etc. The polyolefin cyclic materials are amenable to thermosetting.

In some embodiments, the polymerizable adhesive composition comprises dicyclopentadiene (DCPD), depicted as follows:

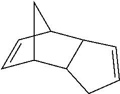

Various DCPD suppliers and purities may be used such as Lyondell 108 (94.6% purity), Veliscol UHP (99+% purity), Cymetech Ultrene (97% and 99% purities), and Hitachi (99+% purity).

In some embodiments, the composition comprises cyclopentadiene oligomers including trimers, tetramers, pentamers, and the like; depicted as follows:

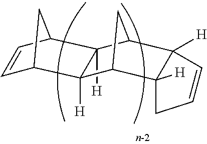

cyclopentadiene oligomers, n is typically 3, 4 or 5.

In some embodiments, the composition comprises cyclic diene monomer in the absence of mono-olefins.

In other embodiments, the composition further comprises a cyclic mono-olefin. Examples include cyclopentene, cyclohexene, cycloheptene, cyclooctene, cyclononene, cyclodecene, cycloundecene, cyclododecene, tricyclodecene, tetracyclodecene, octacyclodecene, and cycloeicosene, and substituted versions thereof such as 1-methylcyclopentene, 1-ethylcyclopentene, 1-isopropylcyclohexene, 1-chloropentene, 1-fluorocyclopentene, 4-methylcyclopentene, 4-methoxy-cyclopentene, 4-ethoxy-cyclopentene, cyclopent-3-ene-thiol, cyclopent-3-ene, 4-methylsulfanyl-cyclopentene, 3-methylcyclohexene, 1-methylcyclooctene, 1,5-dimethylcyclooctene, etc.

In some embodiments, the composition further comprises norbornene, depicted as follows:

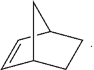

Suitable norbornene monomers include substituted norbornenes such as norbornene dicarboxylic anhydride (nadic anhydride); and as well as alkyl and cycloalkyl norbornenes including butyl norbornene, hexyl norbornene, octyl norbornene, decyl norbornene, and the like.

The cyclic olefin monomers and oligomers may optionally comprise substituents provided the monomer, oligomer, or mixture is suitable for metathesis reactions. The carbon atoms of the cyclic olefin moiety may optionally comprise substituents derived from radical fragments including halogens, pseudohalogens, alkyl, aryl, acyl, carboxyl, alkoxy, alkyl- and arylthiolate, amino, aminoalkyl, and the like, or in which one or more carbon atoms have been replaced by, for example, silicon, oxygen, sulfur, nitrogen, phosphorus, antimony, or boron. For example, the olefin may be substituted with one or more groups such as thiol, thioether, ketone, aldehyde, ester, ether, amine, amide, nitro, carboxylic acid, disulfide, carbonate, isocyanate, phosphate, phosphite, sulfate, sulfite, sulfonyl, carbodiimide, carboalkoxy, carbamate, halogen, or pseudohalogen. Similarly, the olefin may be substituted with one or more groups such as C1-C20 alkyl, aryl, acyl, C1-C20 alkoxide, aryloxide, C3-C20 alkyldiketonate, aryldiketonate, C1-C20 carboxylate, arylsulfonate, C1-C20 alkylsulfonate, C1-C20 alkylthio, arylthio, C1-C20 alkylsulfonyl, C1-C20 alkylsulfinyl, C-C20 alkylphosphate, and arylphosphate.

Preferred cyclic olefins can include dicyclopentadiene; tricyclopentadiene; dicyclohexadiene; norbornene; 5-methyl-2-norbornene; 5-ethyl-2-norbornene; 5-isobutyl-2-norbornene; 5,6-dimethyl-2-norbornene; 5-phenylnorbornene; 5-benzylnorbornene; 5-acetylnorbornene; 5-methoxycarbonylnorbornene; 5-ethoxycarbonyl-1-norbornene; 5-methyl-5-methoxy-carbonylnorbornene; 5-cyanonorbornene; 5,5,6-trimethyl-2-norbornene; cyclo-hexenylnorbornene; endo, exo-5,6-dimethoxynorbornene; endo, endo-5,6-dimethoxynorbornene; endo, exo-5-6-dimethoxycarbonylnorbornene; endo, endo-5,6-dimethoxycarbonylnorbornene; 2,3-dimethoxynorbornene; norbornadiene; tricycloundecene; tetracyclododecene; 8-methyltetracyclododecene; 8-ethyl-tetracyclododecene; 8-methoxycarbonyltetracyclododecene; 8-methyl-8-tetracyclo-dodecene; 8-cyanotetracyclododecene; pentacyclopentadecene; pentacyclohexadecene; higher order oligomers of cyclopentadiene such as cyclopentadiene tetramer, cyclopentadiene pentamer, and the like; and C₂-C₁₂ hydrocarbyl substituted norbornenes such as 5-butyl-2-norbornene; 5-hexyl-2-norbornene; 5-octyl-2-norbornene; 5-decyl-2-norbornene; 5-dodecyl-2-norbornene; 5-vinyl-2-norbornene; 5-ethylidene-2-norbornene; 5-isopropenyl-2-norbornene; 5-propenyl-2-norbornene; and 5-butenyl-2-norbornene, and the like. More preferred cyclic olefins include dicyclopentadiene, tricyclopentadiene, and higher order oligomers of cyclopentadiene, such as cyclopentadiene tetramer, cyclopentadiene pentamer, and the like, tetracyclododecene, norbornene, and C₂-C₁₂ hydrocarbyl substituted norbornenes, such as 5-butyl-2-norbornene, 5-hexyl-2-norbornene, 5-octyl-2-norbornene, 5-decyl-2-norbornene, 5-dodecyl-2-norbornene, 5-vinyl-2-norbornene, 5-ethylidene-2-norbornene, 5-isopropenyl-2-norbornene, 5-propenyl-2-norbornene, 5-butenyl-2-norbornene, and the like.

The cyclic olefins may be used alone or mixed with each other in various combinations to adjust the properties of the olefin monomer composition. For example, mixtures of cyclopentadiene dimer and trimers offer a reduced melting point and yield cured olefin copolymers with increased mechanical strength and stiffness relative to pure poly-DCPD. As another example, incorporation of norbornene, or alkyl norbornene comonomers tend to yield cured olefin copolymers that are relatively soft and rubbery.

In some embodiments, the cyclic olefin material comprises a mixture of DCPD monomer and cyclopentadiene oligomer. In some embodiments, the mixture comprises at least 25, 30, 35, 40 or 45 wt. % DCPD based on the total amount of cyclic olefin monomer(s) and oligomer(s). In some embodiments, the mixture comprises no greater than 75, 70, 65, 60, 55, or 50 wt. % DCPD based on the total amount of cyclic olefin monomer(s) and oligomer(s). In some embodiments, the mixture comprises at least 15, 20, 25, 30, or 35 wt. % of cyclic olefin oligomers, such as cyclopentadiene trimer and/or tetramer based on the total amount a cyclic olefin monomer(s) and oligomer(s). In some embodiments, the mixture comprises no greater than 60, 55, 50, 45, or 40 wt. % of cyclic olefin oligomers, such as cyclopentadiene trimer and/or tetramer based on the total amount of cyclic olefin monomer(s) and oligomer(s). In some embodiments, the mixture comprises at least 2, 3, 4, or 5 wt. % of cyclic olefin oligomers having greater than four cyclopentadiene repeat units, such as cyclopentadiene pentamer. In some embodiments, the mixture comprises no greater than 10, 9, 8, 7, 6, or 5 wt. % of cyclic olefin oligomers having greater than four cyclopentadiene repeat units, such as cyclopentadiene pentamer.

In some embodiments, the cyclic olefin material comprises a mixture of DCPD monomer and cyclopentadiene oligomer, in the absence of mono-olefins or in combination with a low concentration of mono-olefin. In this embodiment, the amount of mono-olefin is less than 25, 20, 15, 10, 9, 8, 7, 6, 5, 4, 3, 2, or 1 wt. % based on the total amount of cyclic olefin monomer(s) and oligomer(s).

In other embodiments, the mixture comprises at least 25, 30, 35, 40 or 45 wt. % of a mono-olefin such as a substituted norbornene, based on the total amount of cyclic olefin monomer(s) and oligomer(s). In some embodiments, the mixture comprises no greater than 75, 70, 65, 60, 55, or 50 wt. % mono-olefin (e.g. C4-C12 (e.g. C8) alkyl norbornene) based on the total amount of cyclic olefin monomer(s) and oligomer(s). In some embodiments, the mixture comprises at least 15, 20, 25, 30, or 35 wt. % of cyclic olefin oligomers, such as cyclopentadiene trimer and/or tetramer based on the total amount a cyclic olefin monomer(s) and oligomer(s). In some embodiments, the mixture comprises no greater than 60, 55, 50, 45, or 40 wt. % of cyclic olefin oligomers, such as cyclopentadiene trimer and/or tetramer based on the total amount of cyclic olefin monomer(s) and oligomer(s). In some embodiments, the mixture comprises at least 2, 3, 4, or 5 wt. % of cyclic olefin oligomers having greater than four cyclopentadiene repeat units, such as cyclopentadiene pentamer. In some embodiments, the mixture comprises no greater than 10, 9, 8, 7, 6, or 5 wt. % of cyclic olefin oligomers having greater than four cyclopentadiene repeat units, such as cyclopentadiene pentamer. In some embodiments, the mixture comprises no greater than 5, 4, 3, 2, or 1 wt. % of DCPD monomer. In other embodiments, the mixture comprises no greater than 25 or 20 wt. % of DCPD monomer.

The adhesive composition comprises at least 10, 11, 12, 14, or 15 wt. % of cyclic olefin (i.e. polyolefin and optional mono-olefin) of the sum of cyclic olefin(s) and polymer. In some embodiments, the amount of cyclic olefin is at least 16, 17, 18, 19, or 20 wt. % of the sum of cyclic olefin(s) and polymer. In some embodiments, the amount of cyclic olefin is at least 25, 30, 35, 40, 45, or 25 wt. % of the sum of cyclic olefin(s) and polymer. The amount of cyclic olefin (i.e. polyolefin and optional mono-olefin) is typically no greater than 80 wt. % of the sum of cyclic olefin(s) and polymer. In some embodiments, the amount of cyclic olefin is no greater than 75, 70, 55, 60, 55, or 50 wt. % of the sum or cyclic olefin(s) and polymer.

Various cyclic olefins are commercially available from Materia.

The adhesive compositions described herein are prepared by the metathesis of cyclic olefins polymerized with a metal carbene catalyst. Group 8 transition metals, such as ruthenium and osmium, carbene compounds have been described as effective catalysts for ring opening metathesis polymerization (ROMP). See for example U.S. Pat. No. 10,239,965; incorporated herein by reference.

In typical embodiments, the catalyst is a metal carbene olefin metathesis catalyst. Such catalysts typically have the following structure:

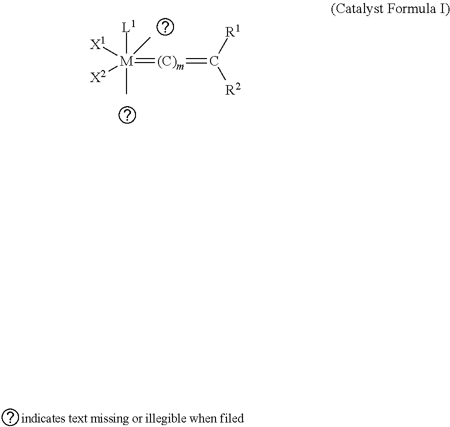

wherein
M is a Group 8 transition metal;
L¹, L², and L³ are independently neutral electron donor ligands;
n is 0 or 1;
m is 0, 1, or 2;
k is 0 or 1;
X¹ and X² are independently anionic ligands; and
R¹ and R² are independently selected from hydrogen, hydrocarbyl, substituted hydrocarbyl, heteroatom-containing hydrocarbyl, substituted heteroatom-containing hydrocarbyl, and functional groups.

Typical metal carbene olefin metathesis catalysts contain Ru or Os as the Group 8 transition metal, with Ru being preferred.

A first group of metal carbene olefin metathesis catalysts are commonly referred to as First Generation Grubbs-type catalysts, and have the structure of Catalyst Formula (I). For the first group of metal carbene olefin metathesis catalysts, M is a Group 8 transition metal, m is 0, 1, or 2, and n, X¹, X², L¹, L², and L³ are described as follows.

For the first group of metal carbene olefin metathesis catalysts, n is 0, and L¹ and L² are independently selected from phosphine, sulfonated phosphine, phosphite, phosphinite, phosphonite, arsine, stibine, ether, (including cyclic ethers), amine, amide, imine, sulfoxide, carboxyl, nitrosyl, pyridine, substituted pyridine, imidazole, substituted imidazole, pyrazine, substituted pyrazine and thioether. Exemplary ligands are trisubstituted phosphines. Typical trisubstituted phosphines are of the formula PR^{H1}R^{H2}R^{H3}, where R^{H1}, R^{H2}, and R^{H3} are each independently substituted or unsubstituted aryl or C1-C10 alkyl, particularly primary alkyl, secondary alkyl, or cycloalkyl. In some embodiments, L¹ and L² are independently selected from the group consisting of trimethylphosphine (PMe₃), triethylphosphine (PEt₃), tri-n-butylphosphine (PBu₃), tri(ortho-tolyl)phosphine (P-o-tolyl₃), tri-tert-butvlphosphine (P-tert-Bu₃), tricyclopentylphosphine (PCyclopentyl₃), tricyclohexylphosphine (PCy₃), triisopropylphosphine (P-i-Pr₃), trioctylphosphine (POct₃), triisobutylphosphine, (P-i-Bu₃), triphenylphosphine (PPh₃), tri(pentafluorophenyl)phosphine (P(C₆F₅)₃), methyldiphenylphosphine (PMePh₂), dimethylphenylphosphine (PMe₂Ph), and diethylphenylphosphine (PEt₂Ph). Alternatively, L¹ and L² may be independently selected from phosphabicycloalkane (e.g., monosubstituted 9-phosphabicyclo-[3.3.1]nonane, or monosubstituted 9-phosphabicyclo[4.2.1]nonane] such as cyclohexylphoban, isopropylphoban, ethylphoban, methylphoban, butylphoban, pentylphoban and the like.

X¹ and X² are anionic ligands, and may be the same or different, or are linked together to form a cyclic group, typically although not necessarily a five- to eight-membered ring. In some embodiments, X¹ and X² are each independently hydrogen, halide, or one of the following groups: C1-C20 alkyl, C5-C24 aryl, C1-C20 alkoxy, C5-C24 aryloxy, C2-C20 alkoxycarbonyl, C6-C24 aryloxycarbonyl, C2-C24 acyl, C2-C24 acyloxy, C1-C20 alkylsulfonato, C5-C24 arylsulfonato, C1-C20 alkylsulfanyl, C5-C24 arylsulfanyl, C1-C20 alkylsulfinyl, NO₃, —N═C═O, —N═C═S, or C₅ -C₂₄ arylsulfinyl. Optionally, X¹ and X² may be substituted with one or more moieties selected from C1-C12 alkyl, C1-C12 alkoxy, C5-C24 aryl, and halide, which may, in turn, with the exception of halide, be further substituted with one or more groups selected from halide, C1-C6 alkyl, C1-C6 alkoxy, and phenyl. In some embodiments, X¹ and X² are halide, benzoate, C2-C6 acyl, C2-C6 alkoxycarbonyl, C1-C6 alkyl, phenoxy, C1-C6 alkoxy, C1-C6 alkylsulfanyl, aryl, or C1-C6 alkylsulfonyl. In some preferred embodiments, X¹ and X² are each halide, CF₃CO₂, CH₃CO₂, CFH₂CO₂, (CH₃)₃CO, (CF₃)₂(CH₃)CO, (CF₃)(CH₃)₂CO, PhO, MeO, EtO, tosylate, mesylate, or trifluoromethane-sulfonate. In some preferred embodiments, X¹ and X² are each chloride.

R¹ and R² are independently selected from hydrogen, hydrocarbyl (e.g., C1-C20 alkyl, C2-C20 alkenyl, C2-C20 alkynyl, C5-C24 aryl, C6-C24 alkaryl, C6-C24 aralkyl, etc.), substituted hydrocarbyl (e.g., substituted C1-C20 alkyl, C2-C20 alkenyl, C2-C20 alkynyl, C5-C24 aryl, C6-C24 alkaryl, C6-C24 aralkyl, etc.), heteroatom-containing hydrocarbyl (e.g., heteroatom-containing C1-C20 alkyl, C2-C20 alkenyl, C2-C20 alkynyl, C5-C24 aryl, C6-C24 alkaryl, C6-C24 aralkyl, etc.), and substituted heteroatom-containing hydrocarbyl (e.g., substituted heteroatom-containing C1-C20 alkyl, C2-C20 alkenyl, C2-C20 alkynyl, C5-C24 aryl, C6-C24 alkaryl, C6-C24 aralkyl, etc.), and functional groups. R¹ and R² may also be linked to form a cyclic group, which may be aliphatic or aromatic, and may contain substituents and/or heteroatoms. Generally, such a cyclic group will contain 4 to 12, preferably 5, 6, 7, or 8 ring atoms.

In some embodiments, R¹ is C1-C6 alkyl, C2-C6 alkenyl, and C5-C14 aryl.

In some embodiments, R² is phenyl, vinyl, methyl, isopropyl, or t-butyl, optionally substituted with one or more moieties selected from C1-C6 alkyl, C1-C6 alkoxy, phenyl, and a functional group Fn. Suitable functional groups (“Fn”) include phosphonato, phosphoryl, phosphanyl, phosphino, sulfonato, C1-C20 alkylsulfanyl, C5-C20 arylsulfanyl, C1-C20 alkylsulfonyl, C5-C20 arylsulfonyl, C1-C.20 alkylsulfinyl, C5-C20 arylsulfinyl, sulfonamido, amino, amido, imino, nitro, nitroso, hydroxyl, C1-C20 alkoxy, C5-C20 aryloxy, C2-C20 alkoxycarbonyl, C5-C20 aryloxycarbonyl, carboxyl, carboxylato, mercapto, formyl, C1-C20 thioester, cyano, cyanato, thiocyanato, isocyanate, thioisocyanate, carbamoyl, epoxy, styrenyl, silyl, silyloxy, silanyl, siloxazanyl, boronato, boryl, or halogen, or a metal-containing or metalloid-containing group (wherein the metal may be, for example, Sn or Ge).

In some embodiments, R² is phenyl or vinyl substituted with one or more moieties selected from methyl, ethyl, chloro, bromo, iodo, fluoro, nitro, dimethylamino, methyl, methoxy, and phenyl. In some favored embodiments, R² is phenyl or —CH═C(CH₃)₂.

In some embodiments, one or both of R¹ and R² may have the structure —(W)ₙ—U⁺V⁻, wherein W is selected from hydrocarbylene, substituted hydrocarbylene, heteroatom-containing hydrocarbylene, or substituted heteroatom-containing hydrocarbylene; U is a positively charged Group 15 or Group 16 element substituted with hydrogen, hydrocarbyl, substituted hydrocarbyl, heteroatom-containing hydrocarbyl, or substituted heteroatom-containing hydrocarbyl; V is a negatively charged counterion; and n is zero or 1. Furthermore, R¹ and R² may be taken together to form an indenylidene moiety, such as phenylindenylidene.

In some embodiments, any one or more of X¹, X², L¹, L², L³, R¹ and R² may be attached to a support or two or more (e.g. three or four) of said groups can be bonded to one another to form one or more cyclic groups, including bidentate or multidentate ligands, as disclosed, for example, in U.S. Pat. No. 5,312,940, incorporated herein by reference. When two or more of X¹, X², L¹, L², L³ R¹ and R² are linked to form cyclic groups, those cyclic groups may contain 4 to 12, preferably 4, 5, 6, 7 or 8 atoms, or may comprise two or three of such rings, which may be either fused or linked. The cyclic groups may be aliphatic or aromatic, and may be heteroatom-containing and/or substituted. The cyclic group may, in some cases, form a bidentate ligand or a tridentate ligand. Examples of bidentate ligands include, but are not limited to, bisphosphines, dialkoxides, alkyldiketonates, and aryldiketonates.

Other metal carbene olefin metathesis catalysts, commonly referred to as Second or Third Generation Grubbs-type catalysts, have the structure of Catalyst Formula (I), wherein L¹ is a carbene ligand having the structure of formula (II)

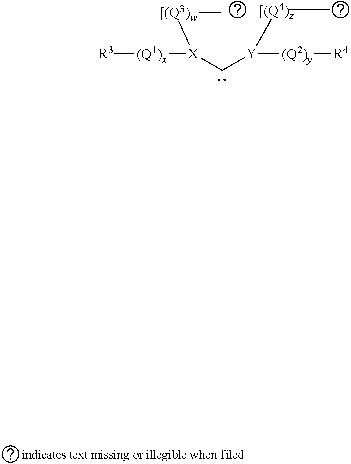

wherein M, m, n, X¹, X², L², L³, R¹ and R² are as previously defined Formula I;

X and Y are heteroatoms typically selected from N, O, S, and P. Since O and S are divalent, p is necessarily zero when X is O or S, q is necessarily zero when Y is O or S, and k is zero or 1. However, when X is N or P, then p is 1, and when Y is N or P, then q is 1. In a preferred embodiment, both X and Y are N;

Q¹, Q², Q³ and Q⁴ are linkers, e.g., hydrocarbylene (including substituted hydrocarbylene, heteroatom-containing hydrocarbylene, and substituted heteroatom-containing hydrocarbylene, such as substituted and/or heteroatom-containing alkylene) or —(CO)—, and w, x, y, and z are independently zero or 1, meaning that each linker is optional. Preferably, w, x, y, and z are all zero. Further, two or more substituents of adjacent atoms within Q¹, Q², Q³, and Q⁴ may be linked to form an additional cyclic group;

R³, R^{3A}, R⁴, and R^{4A} are independently selected from hydrogen, hydrocarbyl, substituted hydrocarbyl, heteroatom-containing hydrocarbyl, and substituted heteroatom-containing hydrocarbyl. In addition, X and Y may be independently selected from carbon and one of the heteroatoms mentioned above, preferably no more than one of X or Y is carbon. Also, L² and L³may be taken together to form a single bindentate electron-donating heterocyclic ligand. Furthermore, R¹ and R² may be taken together to form an indenylidene moiety, preferably phenylindenylidene. Moreover, X¹, X², L², L³, X and Y may be further coordinated to boron or to a carboxylate;

Any two or more of X¹, X², L¹, L², L³, R¹, R² R³, R^{3A}, R⁴, R^{4A}, Q¹, Q², Q³, and Q⁴ can be bonded to one another to form one or more cyclic groups or can also be taken to be -A-Fn, wherein “A” is a divalent hydrocarbon moiety and Fn is a functional group as previously described. Further, with the exception of L¹ such groups may be bonded to a support.

A particular class of such carbene are commonly referred to as N-heterocyclic carbene (NHC) ligands.

Examples of N-heterocyclic carbene (NHC) ligands and acyclic diaminocarbene ligands suitable as L1 thus include, but are not limited to, the following where DIPP or DiPP is diisopropylphenyl and Mes is 2,4,6-trimethylphenyl:

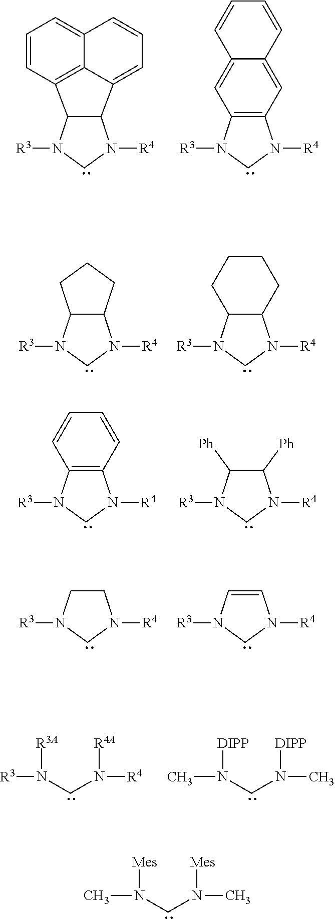

Representative metal carbene olefin metathesis catalysts include for example bis(tricyclohexylphosphine) benzylidene ruthenium dichloride, bis(tricyclohexylphosphine) dimethylvinylmethylidene ruthenium dichloride, bis(tricyclopentylphosphine) dimethylvinylmethylidene ruthenium dichloride, (tricyclohexylphosphine)(1,3-dimesityl-4,5-dihydroimidazol-2-ylidene) benzylidene ruthenium dichloride, (tricyclopentylphosphine)(1,3-dimesityl-4,5-dihydroimidazol-2-ylidene) dimethylvinylmethylidene ruthenium dichloride, (tricyclohexylphosphine)(1,3-dimesityl-4,5-dihydroimidazol-2-ylidene) dimethylvinylmethylidene ruthenium dichloride, (tricyclohexylphosphine)(1,3-dimesitylimidazol-2-ylidene) benzylidene ruthenium dichloride, (tricyclopentylphosphine)(1,3-dimesitylimidazol-2-ylidene) dimethylvinylmethylidene ruthenium dichloride, and (tricyclohexylphosphine)(1,3-dimesitylimidazol-2-ylidene) dimethylvinylmethylidene ruthenium dichloride.

Numerous metal carbene olefin metathesis catalysts are known, such as described in previously cited U.S. Pat. No. 10,239,965.

In some embodiments, the adhesive compositions described herein are two-part compositions wherein the catalyst is separated from the cyclic olefin until the time of use.

In some embodiments, the catalyst may be a latent ring opening metathesis polymerization catalyst. Such catalysts exhibit little or no catalytic activity (e.g. polymerization of the cyclic olefin) for at least 24 hours at room temperature. In some embodiments, the catalyst or precatalyst thereof is sufficiently latent such that the adhesive composition exhibits an overlap shear value with aluminum of less than 30 kPa after at least 24 hours at 25° C. as described in U.S. Application No. 62/951,013. The adhesive or adhesive coated article can be stored at cold temperatures to prevent premature activation of thermally activated catalysts. Likewise, the adhesive or adhesive coated article can be stored in a dark box or dark packaging materials to prevent premature activation of light activated catalysts. In other embodiments, the catalyst or precatalyst thereof is sufficiently latent such that after at least 1 hour (e.g. 4, 8, 12, 24 hours) at 25° C., the adhesive is sufficiently flowable at 25° C. for the desired adhesive application method. In some embodiments, the viscosity at 25° C. is no greater than 250,000; 200,000, 150,000; 100,000; 50,000, or 25,000 cps as measured with a Brookfield viscometer after at least 1 hour (e.g. 4, 8, 12, 24 hours) at 25° C. Latent ring opening metathesis polymerization catalysts can be triggered or in other words activated with heat (i.e. thermal activation), actinic (e.g. ultraviolet) radiation, a chemical compound, or a combination thereof. In some embodiments, the latent ring opening polymerization catalysts are activated by a combination of actinic (e.g. ultraviolet) radiation and an acid compound. In some embodiments, a modified First or Second Generation Grubbs' catalyst as previously described can function as a latent catalyst. One representative latent catalyst is depicted as follows:

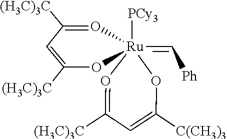

Such catalyst can be activated with an acid, such as a photoacid generator (“PAG”), as depicted in the following reactive scheme:

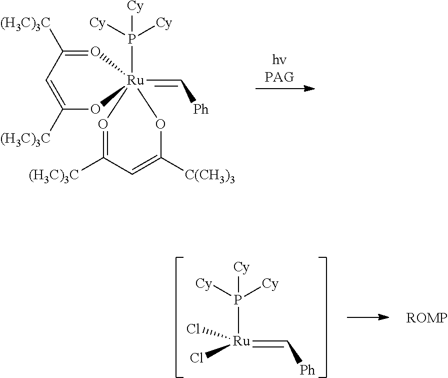

Another class of latent catalysts comprise a carbyne, i.e. a (e.g. Ru) metal carbon triple bond (also described in the literature as (e.g. Ru) metal carbides). These catalysts can be characterized as a ring opening metathesis polymerization precatalysts because such catalysts form a ring opening metathesis polymerization catalyst when reacted with an acid, such as a photoacid generator, as depicted in the following representative reactive scheme:

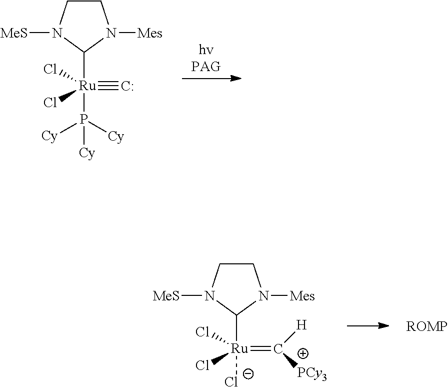

Such ring opening metathesis polymerization precatalysts can have the general formula:

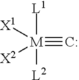

wherein L¹ is a carbene ligand having the structure of formula (II)

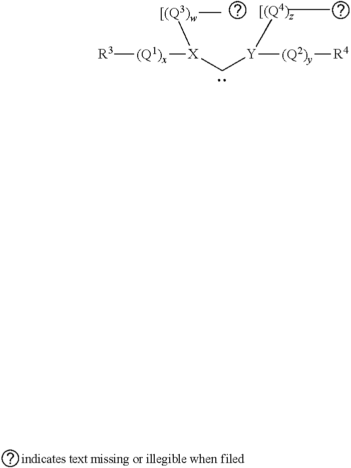

wherein M, X¹, X², and L² are as previously defined for Formula I. In some embodiments, X¹ and X² are chlorine. In some embodiments, L² is PCy₃.

In other embodiments, the latent catalyst can be activated by actinic (e.g. UV) energy in the absence of an acid compound. One class of compounds may be characterized as Fischer-type ruthenium carbene catalysts, such as described in WO2018/045132; incorporated herein by reference. Such catalysts have the following formula or a geometric isomer thereof

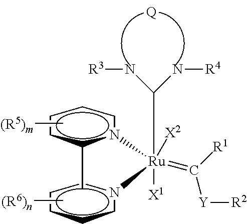

wherein X¹ and X² are independently anionic ligands;
Y is 0, N—R¹, or S; and
Q is a two-atom linkage having the structure —CR¹¹—Ru¹²—CR¹³R¹⁴— or —C¹¹═CR¹³—; wherein R¹¹, R¹², R¹³, and R¹⁴ are independently hydrogen, hydrocarbyl, or a substituted hydrocarbyl;
R¹ and R² independently hydrogen, (optionally substituted) hydrocarbyl, or may be linked together to form an (optionally substituted) cyclic aliphatic group;
R³ and R⁴ are independently (optionally substituted) hydrocarbyl, and
R⁵ R⁶ are independently H, C1-24 alkyl, C1-24 alkoxy, C1-24 fluoroalkyl, C1-24 fluoroalkoxy, C1-24 alkylhydroxy, C1-24 alkoxyhydroxy, C1-24 fluoroalkylhydroxy (including perfluoroalkylhydroxy),
C1-24 fluoroalkoxyhydroxy, halo, cyano, nitro, or hydroxy; and
m and n are independently 1, 2, 3, or 4.

In some embodiments, the moiety

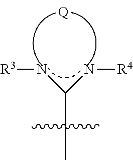

is a N-heterocyclic carbene (NHC) ligand as described above. Other N-heterocyclic carbene (NHC) ligands include:

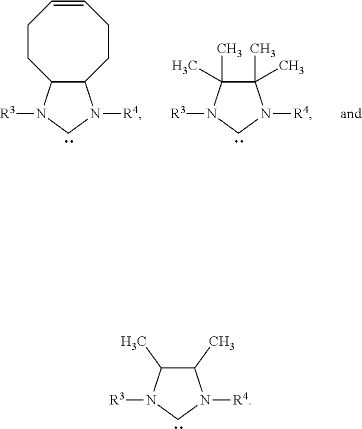

In one embodiment, the metathesis catalyst comprises a compound having the structure:

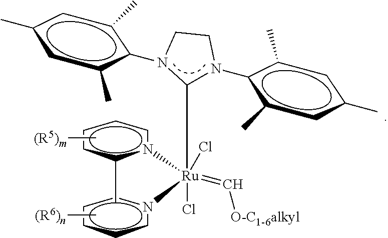

Actinic radiation activated catalyst can be preferred for bonding heat sensitive substrates comprised of organic polymeric materials. However, for bonding other substrates, the latent catalysts may be heat activated. In typical embodiments, the heat activation temperature is well above room temperature. For example, the heat activation temperature is at least 50, 60, 70, 80, 90 or 100° C. The heat activation temperature may range up to 130, 140, or 150° C. In one embodiment, thermally latent catalysts includes isomers that are inactive at room temperature yet active at temperatures ranging from 50° C. to 90° C. One representative catalyst is as follows:

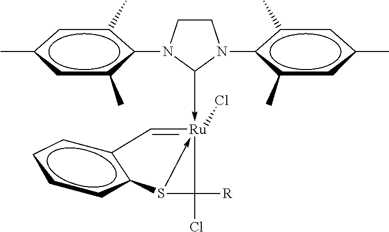

Another class of heat activatable catalyst comprises chelating alkylidene ligands. Some representative catalysts include:

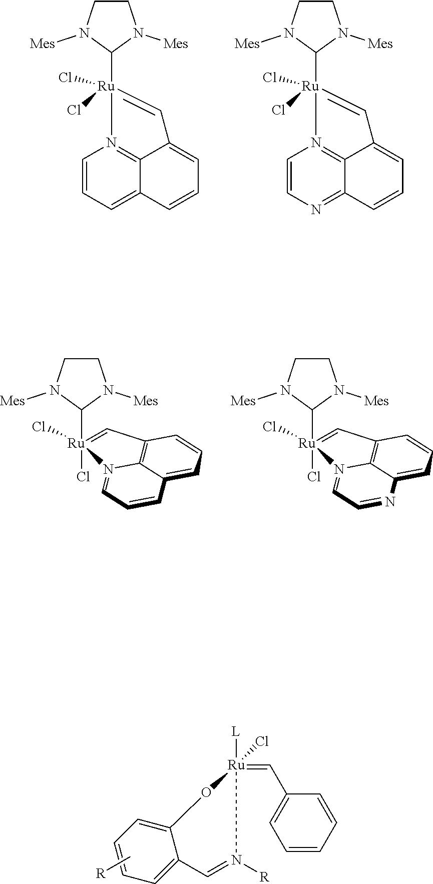

The composition typically comprises the metathesis catalyst in an amount ranging from about 0.0001 wt. % to 2 wt. % catalyst based on the total weight of the composition. In some embodiments, the composition typically comprises at least 0.0005, 0.001, 0.005, 0.01, 0.05, 0.10, 0.15 or 0.20 wt. % catalyst. In some embodiments, the composition typically comprises no greater than 1.5, 1, or 0.5 wt. % catalyst.

In some embodiments, the activation of the latent olefin metathesis catalyst is achieved by the addition of acid, photoacid generator (“PAG”), or thermal acid generator (“TAG”) and exposing the composition to (e.g. ultraviolet) actinic radiation as described in U.S. Application Nos. 62/951,013 and 62/951,037; incorporated herein by reference. When present, the acid, photoacid or thermal acid generator is typically present in the adhesive composition in an amount of at least 0.005 or 0.01 wt. % and typically no greater than 10 wt. % of the composition. In some embodiments, the concentration is no greater than 5, 4, 3, 2, 1, or 0.5 wt. % of the adhesive composition. Alternatively the acid, photoacid generator (“PAG”), or thermal acid generator (“TAG”) can be applied to the substrate the adhesive is applied to.

Suitable ROMP catalysts or precatalysts can polymerize the cyclic olefin via thermal curing, exposure to actinic (e.g. UV) radiation, or a combination thereof.

The composition may optionally further comprise a rate modifier such as, for example, triphenylphosphine (TPP), tricyclopentylphosphine, tricyclohexylphosphine, triisopropylphosphine, trialkylphosphites, triarylphosphites, mixed phosphites, pyridine, or other Lewis base. The rate modifier may be added to the cyclic olefin component to retard or accelerate the rate of polymerization as required. The amount of rate modifier can be the same amounts just described for the catalyst. Typically, the amount of rate modifier is less than 0.01 or 0.005 wt. % based on the total amount of cyclic olefin.

The (e.g. liquid) adhesive composition further comprises a polymer. In some embodiments, the polymer thickens the liquid adhesive composition. In other embodiments, the polymer can be characterized as an adhesion promoter.

The composition further comprises an adhesion promoter.

In some embodiments, the adhesion promoter is a compound or polymer containing at least two isocyanate groups. The adhesion promoter may be a diisocyanate, triisocyanate, or polyisocyanate (i.e., containing four or more isocyanate groups). The adhesion promoter may be a mixture of at least one diisocyanate, triisocyanate, or polyisocyanate. In some embodiments, the adhesion promoter is a diisocyanate compound, or mixtures of diisocyanate compounds.

In some embodiments, the adhesion promoters are polymeric polyisocyanates (e.g. diisocyanate) such as polyisocyanate prepolymers available from Covestro including the trade designations DESMODUR E-28 (MDI based) and Baytec ME-230 (modified MDI based on polytetramethylene ether glycol (PTMEG). Such polymeric polyisocyanates (e.g. diisocyanates) comprise C2-C4 alkylene oxide repeat units. Such polymeric polyisocyanates (e.g. diisocyanates) are typically the reaction product of a polyether polyol and a polyisocyanate (e.g. diisocyanate). Further, such polymeric polyisocyanates typically have an average equivalent weight ranging from 200-5000 g/mole per isocyanate group.

In some embodiments, the polymeric isocyanate adhesion promoter is typically the reaction product of a polyol and aliphatic diisocyanate such as MDI. The polyol typically has one or more oxygen atoms in the backbone such as in the case of polytetramethylene ether glycol and polypropylene oxide.

In some embodiments, the (e.g. polytetramethylene ether glycol) polyol has a molecular weight of about 90 g/mol. In other embodiments, the(e.g. polytetramethylene ether glycol) polyol has a molecular weight of at least 200, 300, 400, 500, 600, 700, 800, 900, 1000, 1100, 1200, 1300, 1400, 1500, 1600, 1700, 1800, 1900, or 2000 g/mol. Such polymeric isocyanate may have a NCO content of greater than 15, 16, 17, 18, 19, or 20 wt. %. The NCO content is typically no greater than 25 wt. %.

In some embodiments, the (e.g. polypropylene oxide) polyol has a molecular weight of at least 1000, 1100, 1200, 1300, 1400, 1500, 1600, 1700, 1800, 1900, or 2000 g/mol. The amount of polymerized polyol is typically less than 55, 50, 45, or 40 wt. % of the polymeric isocyanate. Such polymeric isocyanate may have a NCO content of greater than 3, 5, 10, 11, 12, 13, 14, or 15 wt. %. The NCO content is typically no greater than 20 wt. %. The equivalent weight of the polymeric polyol can be less than 400, 350, or 300 g/mole/NCO group. The equivalent weight is typically at least 150, 200 or 250 g/mole/NCO group.

In other embodiments, the polymeric adhesion promoters comprise other functional groups such as maleic anhydride or silicon-containing moieties; or a combination thereof. The functional groups may be present as terminal groups, pendent groups or in other words side chains, or a combination thereof.

In some embodiments, the composition may comprise a maleic anhydride grafted polymer as an adhesion promoter such as available under the trade designation “POLYVEST MA 75” from Evonik, Essen, Germany and under the trade designation “RICON 130 Maleinized Polybutadiene 131MA10” from Cray Valley, Exton, Pa.

In some embodiments, the polymers may be characterized as polyolefins. The polyolefins may be unsaturated, comprising alkene moieties, such as polybutadiene. In some embodiments, the polymeric (e.g. polyolefin adhesion promoter has a (e.g. 1,2) vinyl content of at least 10, 15 or 20 wt. %. In some embodiments, the polymeric (e.g. polyolefin adhesion promoter has a (e.g. 1,2) vinyl content of no greater than 40, 35, or 30 w-%. Unlike styrenic block copolymers, the olefin polymers lack polystyrene blocks. However, the polyolefin may comprise other moieties provided the inclusion of such does not detract from the adhesion improvement.

In some embodiments, the polymeric (e.g. polyolefin) adhesion promoters have an average anhydride equivalent weight ranging from 200-5000 g/mole per anhydride group. In some embodiments, the average anhydride equivalent weight ranging is no greater than 4000, 3000, 2000, 1000 or g/mole per anhydride group.

In some embodiments, the polymeric (e.g. polyolefin) adhesion promoters have an average silicon-containing moiety functionality of greater than 1 or 1.5. In some embodiments, the average silicon-containing moiety functionality ranges up to 2.5. In some embodiments, the silicon (i.e. atom)-containing moiety may be an alkoxy silane moiety comprising one or more (C1, C2, C3, or C4) alkoxy groups bonded to the silicon atom. The adhesion promoters may be characterized as an alkoxysilane terminated polyolefin such as di or tri (C1-C4)alkoxysilane-terminated polybutadiene. Triethoxysilane-terminated liquid polybutadiene is commercially available from Evonik and Ricon.

The (e.g. polymeric polyisocyanate or polymeric (e.g. polyolefin) polymer comprising maleic anhydride or silicon-containing moieties) adhesion promoter is a liquid, typically having a viscosity at 20 or 25° C. of at least 2000, 3000, 4000, or 5000 mPas. (DIN EN ISO 3219). In some embodiments, the viscosity at 20 or 25° C. is no greater than 75,000 mPas. In some embodiments, the viscosity is no greater than 30,000, 25,000, 20,000, or 15,000 or 10,000 mPas. In some embodiments, the viscosity is less than 1000 or 500 mPas. In other embodiments, the adhesion promoter may have a viscosity of at least 50,000; 75,000; 100,000; 125,000 or 150,000 mPas at 45, 50, or 55° C. The viscosity is indicative of the molecular weight. Liquid adhesion promoters can be combined with the liquid unpolymerized cyclic olefin more easily than solids, resulting in the adhesion promoter being more uniformly dispersed within the mixture.

The adhesion promoter is polymeric i.e. having a backbone with (e.g. polyether or polyolefin) repeat units. In typical embodiments, the polymeric adhesion promoter has a molecular weight (Mn) of no greater than 10,000; 9,000; 8,000; 7,000; or 6,000 g/mole. In some embodiments, the polymeric adhesion promoter has a molecular weight (Mn) of no greater than 5,000; 4,500; 4,000; 3,500; or 3,000 g/mole. In some embodiments, the polymeric adhesion promoter has a molecular weight (Mn) has a molecular weight of at least 1000, 1100, 1200, 1300, 1400, 1500, 1600, 1700, 1800, 1900, or 2000 g/mole.

The adhesion promoter polymers as described herein can be used in combination with additional adhesion promoters described in the art.

In some embodiments, such as when a polymeric (e.g. polyolefin) adhesion promoter with maleic acid and/or silicon-containing moieties is utilized, the adhesion promoter and overall composition may be free of isocyanate moieties.

In some embodiments, the additional adhesion promoter is an aliphatic diisocyanate. Aliphatic diisocyanates comprise a linear, branched, or cyclic saturated or unsaturated hydrocarbon group typically containing 1 to about 24 carbon atoms. In some embodiments, the alkyl diisocyanate contains at least 2, 3, 4, 5, or 6 carbon atoms. In some embodiments, the aliphatic diisocyanate contains no greater than 22, 20, 18, 16, 14, or 12 carbon atoms. Representative examples include hexamethylene diisocyanate (HDI), octamethylene diisocyanate, decamethylene diisocyanate, and the like. In some embodiments, the aliphatic diisocyanate comprises a cycloaliphatic (e.g. cycloalkyl) moiety, typically having 4 to 16 carbon atoms, such as cyclohexyl, cyclooctyl, cyclodecyl, and the like. In one embodiments, the cycloalkyl diisocyanate is isophorone diisocyanate (IPDI) and the isomers of isocyanato-[(isocyanatocyclohexyl) methyl]cyclohexane (H₁₂MDI).

In some embodiments, the additional adhesion promoter is an aromatic diisocyanate. Aromatic diisocyanates include one or more aromatic rings that are fused together or covalently bonded with an organic linking group such as an alkylene (e.g. methylene or ethylene) moiety. Representative aromatic moieties include phenyl, tolyl, xylyl, napthyl, biphenyl, diphenylether, benzophenone, and the like. Suitable aromatic diisocyanates contain 6 to 24 carbon atoms, such as toluene diisocyanates, xylene diisocyanate, xylylene diisocyanate, tetramethylxylylene diisocyanate (TMXDI), and methylene diphenyl diisocyanate (MDI), that may comprise any mixture of its three isomers, 2.2′-MDI, 2,4′-MDI, and 4,4′-MDI.

Other polymeric isocyanates include for example PM200 (poly MDI), Lupranate™ (poly MDI from BASF), various isocyanate terminated polybutadiene prepolymers available from Cray Valley including Krasol™ LBD2000 (TDI based), Krasol™ LBD3000 (TDI based), Krasol™ NN-22 (MDI based), Krasol™ NN-23 (MDI based), and Krasol™ NN-25 (MDI based).

In some embodiments, the additional adhesion promoter is a maleic-anhydride grafted styrene-ethylene/butylene-styrene hydrogenated copolymer, typically comprising at least 0.1, 0.2, 0.3, 0.4 or 0.5 wt. % of grafted maleic anhydride. The amount of grafted maleic anhydride is typically no greater than 7, 6, 5, 4, 3, or 2 wt. %. Maleic-anhydride grafted styrene-ethylene/butylene-styrene hydrogenated copolymers typically comprise at least 10 and no greater than 60, 50, or 40% polystyrene. Suitable functional elastomers are commercially available from Kraton Performance Polymers as the trade designations “Kraton FG1901G” and “Kraton FG1924G”. The amount of (e.g. functional) elastomer when present in typically at least 0.001, 0.05, or 0.1 wt. % based on the weight of the cyclic olefin.

The composition typically comprises at least 0.005, 0.010, 0.050, 0.10, 0.50, or 1 wt. % of adhesion promoter based on the total weight of the composition. In some embodiments, the amount of adhesion promoter is no greater than 10, 9, 8, 7, 6, 5, 4, 3, 2, or 1 wt. % of the total weight of the composition. In some embodiments, the adhesion promoter comprises one or more polymeric polyisocyanate (e.g. diisocyanate) comprising oxygen atoms in the backbone. In some embodiments, the adhesion promoter comprises one or more polyolefins comprising maleic anhydride moieties. In some embodiments, the adhesion promoter comprises at least one polymeric polyisocyanate (e.g. diisocyanate) comprising oxygen atoms in the backbone and at least one polyolefin comprising maleic anhydride moieties. When two adhesion promoters are used, the amount of each adhesion promoter is typically less than 5, 4, 3, 2, or 1 wt. % of the total weight of the composition.

The adhesive compositions may optionally contain one or more conventional additives. Preferred additives include tackifiers, plasticizers, antioxidants, UV stabilizers, colorants (e.g. carbon black) and (e.g. inorganic) fillers such as (e.g. fumed) silica, (e.g. phlogopite) mica and glass and ceramic bubbles; as well as (e.g. polyethylene) polymeric and inorganic fibers.

The cyclic olefin, polymer, and other components can be combined in various methods. In some embodiments, the materials are combined in an organic solvent such as toluene and ethyl acetate.

The adhesive composition can be coated on a substrate using conventional coating techniques. For example, these compositions can be applied to a variety of substrates by methods such as roller coating, flow coating, dip coating, spin coating, spray coating, knife coating, and die coating. Coating (dry) thickness typically ranges from 25 (e.g. about 1 mil) to 1500 microns (60 mils). In some embodiments, the coating thickness ranges from about 50 to 350 microns.

The method of applying and polymerizing the cyclic olefin of the composition will vary depending on the desired use of the composition. In favored embodiments, polymerization occurs after applying the adhesive article or adhesive composition to a substrate. However, in alternative embodiments polymerization of the composition (at least in part) may occurs prior to applying the composition to a substrate or concurrently with application to a substrate.

The adhesive composition may be coated upon a variety of flexible and inflexible substrates. Examples include for example plastic films such as polyolefins (e.g. polypropylene, polyethylene), polyvinyl chloride, polyester (polyethylene terephthalate), polycarbonate, polymethyl(meth)acrylate (PMMA), cellulose acetate, cellulose triacetate, and ethyl cellulose. In some embodiments, the substrate is comprised of a bio-based material such as polylactic acid (PLA).

Substrates may also be prepared of fabric such as woven fabric formed of synthetic or natural fibrous materials such as cotton, nylon, rayon, glass, ceramic materials, and the like or nonwoven fabric such as air laid webs of natural or synthetic fibers or blends of these.

The substrate may also be formed of metal (e.g. steel, aluminum, copper), metalized polymer films, ceramic sheet materials, or foam (e.g., polyacrylic, polyethylene, polyurethane, neoprene), and the like.

Advantageously, the described adhesion promoters are suitable for bonding to substrates that are notoriously difficult to bond to engineered plastics such as polyamide (e.g. nylon 6, nylon 6,6), polyether sulfone (PES), polystyrene (PS), polyphenylene sulfide (PPS), polyether ether ketone (PEEK) polyether imide (PEI). In some embodiments, the engineered plastic has a melting point of at least 150° C. or 200° C. In some embodiments, the engineered plastic has a melting point no greater than 375° C. or 350° C. The melting point of such material is described in Polymer Data Handbook, edited by James E. Mark, Oxford University Press (1999). In some embodiments, the substrate is a film, sheet, or (e.g. non-planar) molded plastic article. Such substrates typically lack fibers and thus the adhesive composition forms surface bonds rather than bonds formed by physical entanglement of fibers.

When the cyclic olefin is polymerized with a ROMP catalyst activated by exposure to actinic (e.g. UV) radiation, the adhesive composition (e.g. of the adhesive article) may be irradiated with activating UV radiation having a UVA maximum at a wavelength range of 280 to 425 nanometers. UV light sources can be of various types. Low light intensity sources, such as blacklights, generally provide intensities ranging from 0.1 or 0.5 mW/cm² (milliwatts per square centimeter) to 10 mW/cm² (as measured in accordance with procedures approved by the United States National Institute of Standards and Technology as, for example, with a UVIMAP UM 365 L-S radiometer manufactured by Electronic Instrumentation & Technology, Inc., in Sterling, Va.). High light intensity sources generally provide intensities greater than 10, 15, or 20 mW/cm² ranging up to 450 mW/cm² or greater. In some embodiments, high intensity light sources provide intensities up to 500, 600, 700, 800, 900 or 1000 mW/cm². UV light to polymerize the cyclic olefin(s) can be provided by various light sources such as light emitting diodes (LEDs), blacklights, medium pressure mercury lamps, etc. or a combination thereof. The cyclic olefin(s) can also be polymerized with higher intensity light sources as available from Fusion UV Systems Inc. The UV exposure time for polymerization and curing can vary depending on the intensity of the light source(s) used. For example, complete curing with a low intensity light source can be accomplished with an exposure time ranging from about 30 to 300 seconds; whereas complete curing with a high intensity light source can be accomplished with shorter exposure time ranging from about 5 to 20 seconds. Partial curing with a high intensity light source can typically be accomplished with exposure times ranging from about 2 seconds to about 5 or 10 seconds.

Alternatively or in combination thereof, when the cyclic olefin is polymerized with a thermally activated ROMP catalyst, the adhesive is heated as previously described.

The adhesive composition is typically not a pressure sensitive adhesive after polymerizing the cyclic olefin. In this embodiment, the storage modulus (G′) of the adhesive after polymerizing the cyclic olefin is at least (e.g. 25° C.) 3×10⁵ Pa at a frequency of 1 Hz. In some embodiments, the adhesive composition has a storage modulus of a least than 4×10⁵ Pa, 5×10⁵ Pa, 6×10⁵ Pa, 7×10⁵ Pa, 8×10⁵ Pa, 9×10⁵ Pa, 1×10⁶ Pa, 2×10⁶ Pa, 3×10⁶ Pa, 4×10⁶ Pa, 5×10⁶ Pa or greater after polymerizing the cyclic olefin. In this embodiment, the adhesive composition may be characterized as a structural adhesive composition.

In some embodiments, the polymerizable composition provides a structural or semi-structural adhesive composition in which the composition may be disposed between two substrates and subsequently fully cured to create a structural or semi-structural bond between the substrates. “Semi-structural adhesives” are those cured adhesives that have an overlap shear strength (according to the test method of the examples) of at least about 0.5 MPa, more preferably at least about 1.0 MPa, and most preferably at least about 1.5 MPa. Those cured adhesives having particularly high overlap shear strength, however, are referred to as structural adhesives. “Structural adhesives” are those cured adhesives that have an overlap shear strength of at least about 3.5 MPa, more preferably at least about 5 MPa, and most preferably at least about 7 MPa. The overlap shear strength can be tested according to the test method described in the examples using a crosshead speed of 0.1 or 0.05 inches/min. Various substrates can be utilized for overlap sheer testing including metal (e.g. steel, aluminum, copper,) or engineered plastics such as previously described.

Since the adhesive compositions comprising adhesion promoters, as described herein, have been found to exhibit high overlap shear strength to metal substrates including aluminum; the adhesives are suitable for use for electric vehicle cold plate bonding, such as described in WO2020/121244; incorporated herein by reference. The cyclic olefin-based adhesive described can be preferred over epoxy structural adhesives for electric vehicle cold plate bonding since the adhesive lacks reactive sites that are subject to hydrolysis. Furthermore, unlike the higher polarity of epoxies, the nonpolar nature of the cyclic olefin-based adhesive prevents the polar coolant from migrating into the adhesive network, therefore maintaining the glass transitive temperature of the adhesive. The adhesive described herein has been found to be able to maintain sufficient bond strength after exposure to (e.g. water/ethylene glycol) engine coolant, as further described in the examples. Although the adhesive composition comprising a polymeric (e.g. polyolefin) adhesive promoter having silicon-containing moieties provided the highest bond strength after exposure to (e.g. water/ethylene glycol) engine coolant, other adhesion promoters also demonstrated an improvement in performance.

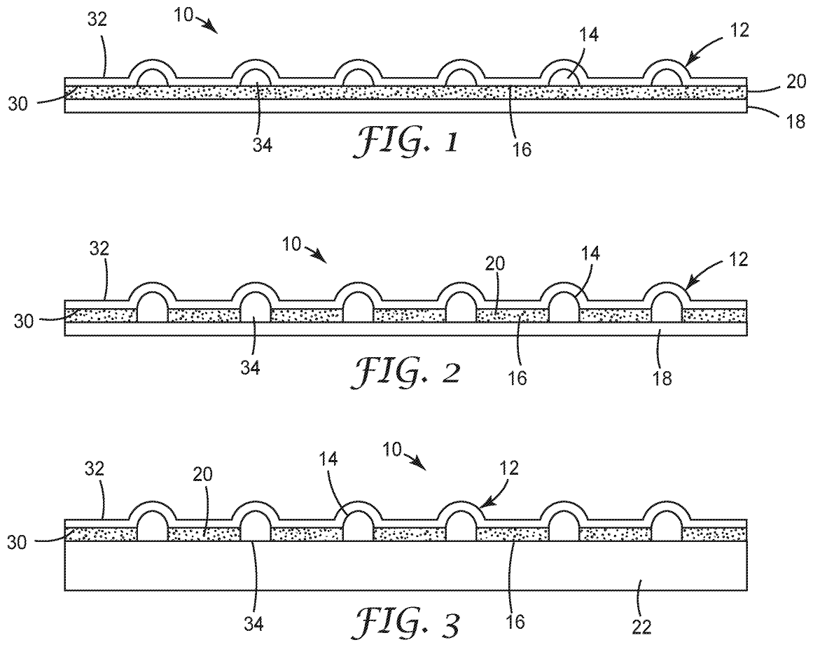

FIGS. 1 and 2 depict illustrative cold plate assemblies 10 for an electric vehicle battery assembly. The cold plate assembly 10 comprises a coolant circulation channel formed by a top plate 12 that is corrugated, stamped or otherwise formed with a patterned open-faced cooling channel 14 and intermediate land area 16, a flat bottom plate 18, and a continuous or mostly continuous (i.e., at least 50% of its surface area is continuous) layer or sheet of adhesive 20 disposed so as to cover and bond together at least most (i.e., at least 50% of the surface area) or all of an upper major surface of the bottom plate 18 and at least most (i.e., at least 50% of the surface area) or all of the intermediate land area 16 of the top plate 12. The channel pattern 14 is formed on the lower major surface 30 of the top plate 12. In FIG. 2, the cold plate assembly 10 for an electric vehicle battery assembly comprises a top plate 12 that is corrugated, stamped or otherwise formed with a patterned open-faced cooling channel 14 and intermediate land area 16, a flat bottom plate 18, and strips or a pattern adhesive 20 disposed so as to cover and bond together at least most (i.e., at least 50% of the surface area) or all of the intermediate land area 16 of the top plate 12 and corresponding area on an upper major surface of the bottom plate 18. In the embodiments shown in FIGS. 1 and 2, the top plate 12 and bottom plate 18 of the cold plate assembly 10 can be made of aluminum or aluminum alloy bonded affixed together with a structural adhesive 20 as described herein. Alternatively, the cold plate components can be made using other metals, metal alloys, sufficiently high temperature plastics, or fiber (e.g., carbon fiber, etc.) reinforced polymeric or ceramic composites. It may also be desirable to use dissimilar materials (e.g., any combination of dissimilar metals, plastics and/or composites) for the cold plate components. When dissimilar metals are chosen (e.g., aluminum and steel) that can induce galvanic corrosion, it can be desirable to use the embodiment of FIG. 1, with the layer of bonding adhesive 20 being continuous and functioning as an isolation barrier.

In FIG. 3, the cold plate assembly 10 for an electric vehicle battery assembly comprises a top plate 12 that is corrugated, stamped or otherwise formed with a patterned open-faced cooling channel 14 and intermediate land area 16 and strips or a pattern of organic bonding agent/adhesive 20 disposed so as to cover and bond together at least most (i.e., at least 50% of the surface area) or all of the intermediate land area 16 of the top plate 12 and corresponding area on an upper major surface of a battery tray 22.

Objects and advantages of this invention are further illustrated by the following examples. The particular materials and amounts, as well as other conditions and details, recited in these examples should not be used to unduly limit this invention.

### EXAMPLES

Unless otherwise noted or readily apparent from the context, all parts, percentages, ratios, etc. in the Examples and the rest of the specification are by weight.

TABLE 1
Materials Used in the Examples

| Abbreviation | Description |
|---|---|
| E28 | Polyisocyanate prepolymer based on diphenylmethane diisocyanate, obtained |
| | under the trade designation “DESMODUR E28” from Covestro, Leverkusen, |
| | Germany |
| MA75 | Maleic-anhydride adduct of a low molecular weight 1,4-cis polybutadiene, |
| | obtained under the trade designation “POLYVEST MA 75” from Evonik, |
| | Essen, Germany |
| 131MA10 | A maleated polybutadiene, obtained under the trade designation “RICON |
| | 131 Maleinized Polybutadiene 131MA10” from Cray Valley, Exton, PA. |
| ME230 | A modified diphenylmethane diisocyanate (MDI)-terminated polyether |
| | prepolymer based on polytetramethylene ether glycol (PTMEG), obtained |
| | under the trade designation “BAYTEC ME-230” from Covestro, |
| | Leverkusen, Germany. |
| ST-E60 | Silane-terminated linear polybutadiene (silane functionality = 1.5) from |
| | Evonik |
| ST-E100 | Silane-terminated linear polybutadiene (silane functionality = 2.0) from |
| | Evonik |
| HPR 2128 | Cyclic olefin resin, obtained under the trade designation “PROXIMA HPR |
| | 2128” from Materia, Inc., Pasadena, CA. |
| CT-762 | Olefin metathesis catalyst (1% in mineral oil), obtained under the trade |
| | designation “PROXIMA CT 762” from Materia, Inc. |
| TS-720 | Fumed silica, obtained under the trade designation “CAB-O-SIL TS-720” |
| | from Cabot Corporation, Boston, MA |
| R8200 | Fumed silica, obtained under the trade designation “AEROSIL R820” from |
| | Evonik, Essen, Germany |
| Nylon 6/6 | Nylon 6/6 coupons, obtained under the trade designation “NYLON TYPE |
| | 6/6 NATURAL” from Plastics International, Eden Prairie, MN |
| Al | Aluminum coupons, obtained under the trade designation, “ALUM SHT |
| | 2024 T3” from Ryerson, Minneapolis, MN |
| MLQ | Monomeric diphenylmethane diisocyanate (2,4′-MDI and 4,4′-MDI), |
| | obtained under the trade designation “MONDUR MLQ” from Covestro, |
| | Leverkusen, Germany. |
| PB2100 | Linear polybutadiene polymer with hydroxyl end groups (poly(butadiene) di- |
| | ol, Mn = 2,100), obtained under the trade designation “KRASOL LBH 2000” |
| | from Cray Valley, Exton, PA |
| PRES 1 | Automotive coolant comprising water and ethylene glycol, obtained under |
| | the trade designation “PRESTONE 1 GALLON YELLOW |
| | CONCENTRATE COOLANT/ANTIFREEZE” from Prestone, Forest Lake, |
| | IL |
| PRES DC | Automotive coolant comprising water and ethylene glycol, obtained under |
| | the trade designation “PRESTONE DEX-COOL 50/50 |
| | ANTIFREEZE/COOLANT” from Prestone, Forest Lake, IL |

### Overlap Shear (OLS) Adhesion Test Method

Two coupons of the specified substrate (1 inch by 4 inch by specified thickness) were cleaned with isopropanol and air-dried (aluminum coupons were abraded with SCOTCH-BRITE GENERAL PURPOSE HAND PAD #7447 (3M) prior to cleaning). At the tip of one coupon, a 1 inch by 0.5 inch area was coated with a thin layer of the prepared formulation with a tongue depressor, and then contacted with another coupon in the opposite tip direction. Paper clamps were used to hold the two halves together during the curing process. The samples were then cured in an oven that is set at 80° C. for at least 3 hours prior to overlap shear testing. The OLS test samples were tested (MTS Insight machine, crosshead speed of 0.1 inch/min, 2250 lb force load cell). The reported value is the “peak stress” in psi of the average of three samples tested.

### Formulation and Testing

In a first compounding step, all the materials except the catalyst were combined and mixed at 2250 rpm for 4 minutes in a small speedmixer cup. Next, the catalyst was added to the adhesive formulation, and the resulting mixture was speedmixed at 2250 rpm for 10-12 seconds; the adhesive was then quickly applied to the substrates for overlap shear (OLS) testing. Each formulation was prepared on a 5 gram scale and all values in the tables (unless otherwise stated) are in wt. %. The formulations were tested and demonstrated good OLS results for materials such as steel, aluminum, copper, Nylon 6, Nylon 6/6, and high-performance polyamide. The results for aluminum substrates are tabulated in Table 2. The results for Nylon 6/6 are tabulated in Table 3.

TABLE 2
Formulations Tested on Aluminum Substrate*

| Material | 1 | 2 | 3 | 4 | 5 | 6 | 7 |
|---|---|---|---|---|---|---|---|
| HPR | 91.5 | 87.5 | 89.5 | 87.5 | 85.5 | 83.5 | 76 |
| 2128 | | | | | | | |
| 131MA10 | | 4.0 | | 2 | 4 | 6 | |
| TS-720 | 7.5 | 7.5 | 7.5 | 7.5 | 7.5 | 7.5 | |
| R8200 | | | | | | | 20.0 |
| E28 | | | 2.0 | 2.0 | 2.0 | 2.0 | |
| ME230 | | | | | | | 3.0 |
| CT-762 | 1.0 | 1.0 | 1.0 | 1.0 | 1.0 | 1.0 | 1.0 |
| OLS (psi) | 135 | 832 | 3626 | 2998 | 2611 | 2756 | 4449 |

*Aluminum coupons with a thickness of 0.063 inch

TABLE 3
Formulations Tested on Nylon*

| | 8 | | | | | | | | | |
|---|---|---|---|---|---|---|---|---|---|---|
| Material | Control | 9 | 10 | 11 | 12 | 13 | 14 | 15 | 16 | 17 |
| HPR 2128 | 79.0 | 89.0 | 88.5 | 87.5 | 85.5 | 83.5 | 73.0 | 73.0 | 76.0 | 66.0 |
| 131MA10 | | 0.5 | 1.0 | 2.0 | 4.0 | 6.0 | | | | |
| MA75 | | | | | | | 3.0 | 3.0 | | |
| TS720 | | 7.5 | 7.5 | 7.5 | 7.5 | 7.5 | | | | |
| R8200 | 20.0 | | | | | | 20.0 | 20.0 | 20.0 | 30.0 |
| E28 | | 2.0 | 2.0 | 2.0 | 2.0 | 2.0 | 3.0 | | | |
| ME230 | | | | | | | | 3.0 | 3.0 | 3.0 |
| CT-762 | 1.0 | 1.0 | 1.0 | 1.0 | 1.0 | 1.0 | 1.0 | 1.0 | 1.0 | 1.0 |
| OLS (psi) | 11 | 590 | 600 | 657 | 716 | 764 | 1014 | 1151 | 930 | 1335 |

*Nylon 6/6 coupons with a thickness of 0.188 inch

The overlap shear strength of Formulation 16 was also tested with aluminum coupons. The result was 4449 psi.

Additional substrates were tested in Table 4. The formulations for Table 4 were prepared as described above using HPR 2128 (98.0 wt. %), E28 (1.0 wt. %), and CT-762 (1.0 wt. %). OLS was tested as described above except only a 0.5 inch by 0.5 inch square was coated at the tip of the coupons and the crosshead speed was 0.05 inch/min. Metal substrates were 0.5 inch wide×4 inch long×0.125 inch thick. Plastic substrates were 1 inch wide×4 inch long×0.25 inch thick.

TABLE 4
Substrate Adhesion Results

| Substrate | OLS (psi) |
|---|---|
| Steel | 2800 |
| Aluminum | 2260 |
| Copper | 1200 |
| Nylon 6 | 585 |
| Nylon 66 | 970 |
| Glass Reinforced Nylon 6 | 890 |
| Kalix ™ polyamide | 1400 |
| available from Solvay | |

A two-part composition was prepared having the following compositions:

| | mass | volume |
|---|---|---|
| Material of First Resin Part | (g) | (cc) |
| HPR 2128 | 6.64 | 6.74 |
| Fumed silica available from Cabot Co. as trade | 0.62 | 0.28 |
| designation “Cab-O-Sil TS720 | | |
| 131MA10 | 0.46 | 0.51 |
| Phlogopite mica filler available from LKAB Mineral | 1.01 | 0.41 |
| Inc., Chicago, IL as trade designation “MicaFort PW80” | | |
| Fibrillated high-density polyethylene fibers available | 0.19 | 0.19 |
| from Mini Fibers Inc., Johnson City, TN as trade | | |
| designation Short Stuff ESS50F | | |
| E28 | 0.19 | 0.16 |
| Carbon black available from Cabot as trade designation | 0.05 | 0.03 |
| “Monarch 120” | | |
| SL300 spacer beads available from Envirospheres SL300, | 0.03 | 0.04 |
| Lindfield, Australia | | |
| Total | 9.19 | 8.36 |

| | mass | volume |
|---|---|---|
| Material of Second Catalyst Dispersion Part | (g) | (cc) |
| CT-762 | 0.19 | 0.19 |
| Mineral oil | 0.64 | 0.64 |
| Total | 0.83 | 0.83 |

The materials of the first resin part were combined in a cup and mixed with a small speedmixer for 4 min at 2250 rpm. Next, the second catalyst part was added and the materials were speedmixed 10-12 seconds at 2250 rpm. The resulting mixture was a 10:1 volume ratio of resin to catalyst dispersion.

Overlap shear samples were then quickly prepared as described above on various substrate (i.e. ⅛″ thick Nylon 6,6, ¼″ thick PEEK and ¼″ thick PEI). The substrates were only wiped with isopropanol solvent prior to bonding. The overlap area between the two bonded substrates was 0.5″×1″. The OLS samples were cured in an oven at 80 C for 3.5 hours.

Overlap shear (OLS) testing was done at 2″/min, and the peak stress was reported along with the failure mode. The results are found in Table 5 below.

TABLE 5
Substrate Adhesion Results

| Substrate | OLS (psi) |
|---|---|
| ⅛″ thick Nylon 6,6 | 962 cohesive |
| ¼″ thick PEEK | 1392 substrate/cohesive |
| ¼″ thick PEI | 1439 cohesive |

Silane terminated polybutadiene adhesion promoters were tested in Table 6 according to the standard formulation and testing method using an aluminum substrate after curing at 80° C. for at least 3 hours prior to testing.

TABLE 6
Silane-terminated Adhesion Promoter Results

| | 18 | | | | | |
|---|---|---|---|---|---|---|
| Material | Control | 19 | 20 | 21 | 22 | 23 |
| HPR 2128 | 79 | 78 | 77 | 76 | 75 | 73 |
| ST-E100 | | 1.0 | 2.0 | 3.0 | 4.0 | 6.0 |
| R8200 | 20 | 20 | 20 | 20 | 20 | 20 |
| CT-762 | 1.0 | 1.0 | 1.0 | 1.0 | 1.0 | 1.0 |
| OLS (psi) | 68 | 1436 | 2326 | 2521 | 2526 | 3141 |

Silane terminated polybutadienes with varying amounts of average silane termination per polymer chain were tested in comparison to polybutadiene in Table 7. These examples were formulated according to the standard method, cured at 80° C. for 18 hours, and tested on aluminum coupons.

TABLE 7
Comparison of the Effectiveness of polybutadiene
(PB), ST-E60, and ST- E100 Adhesion Promoters

| Material | 24 | 25 | 26 |
|---|---|---|---|
| HPR 2128 | 76 | 76 | 76 |
| PB | 3.0 | | |
| ST-E60 | | 3.0 | |
| ST-E100 | | | 3.0 |
| R8200 | 20 | 20 | 20 |
| CT-762 | 1.0 | 1.0 | 1.0 |
| OLS (psi) | 36 | 1931 | 2521 |

A two-part composition was prepared having the following compositions:

| | mass | |
|---|---|---|
| Material of First Resin Part | (g) | Wt. % |
| HPR 2128 | 2.9 | 81 |
| R8200 | 0.7 | 19 |

| | mass | |
|---|---|---|
| Material of Second Catalyst Dispersion Part | (g) | Wt. % |
| R8200 | 3.0 | 30 |
| CT-762 | 2.0 | 20 |
| ST-E100 | 5.0 | 50 |

The materials for the first resin part were combined in a cup and mixed with a small speedmixer for 14 min at 3500 revolutions per minute. The materials for the second catalyst dispersion part were combined in a cup and mixed with a small speed mixer for 1 min at 3500 revolutions per minute. The materials of the first resin part and the second catalyst dispersion part were stored seperately in a 4° C. fridge for 3 weeks. After three weeks, the first resin part and the second catalyst dispersion part were combined in a volume ratio of 10:1 resin to catalyst dispersion and were were speedmixed for 1 min at 3500 revolutions per minute.

The adhesive was then quickly applied to alluminum coupons to cure before overlap shear (OLS) testing. OLS samples were prepared and tested as described above except the aluminum coupons were not abraded prior to cleaning. The samples were cured in an oven set to 85° C. overnight, unless otherwise stated.

TABLE 8
Substrate Adhesion Results

| Substrate | OLS (psi) |
|---|---|
| Aluminum | 2286 |

### PB2100-MLQ (Isocyanate Terminated Polybutadiene) Synthesis

The polymer diol (PB2100) was first dried under high vacuum at 100° C. for three hours. 5.0 g PB2100 was mixed with 5.1 g diisocyanate (MLQ) in a glass vial that was then immediately sealed to minimize exposure to moisture. The reaction mixture was magnetically stirred at 65° C. for 3 hours, before cooling to room temperature.

The formulations for Table 9 were prepared as follows. All the materials were weighed out in a Speedmixer cup and mixed at 3500 revolutions per minute for 30 seconds. Each formulation was prepared on a 5 gram scale and all values in the tables (unless otherwise stated) are in wt. %. The adhesive was then quickly applied to alluminum coupons to cure before overlap shear (OLS) testing. OLS samples were prepared and tested as described above except the aluminum coupons were not abraded prior to cleaning. The samples were cured in an oven set to 85° C. overnight, unless otherwise stated.

### Engine Coolant Resistance Test

To test the long-term resistance of the adhesive to the exposure of ethylene glycol and water, the cured coupons were submerged into one of two different coolants (PRES 1 or PRES DC) then sealed to prevent evaporation. The sealed containers with the coupons and coolant were placed in an oven set to 90° C. The coupons were removed from the containers at various time points.

The formulations were tested and demonstrated that the silane coupling agent containing formulations give better OLS results for accelerated aging in commercial automotive coolants than isocyanate-terminated polybutadiene and maleic anhydride functionalized polybutadiene formulation.

TABLE 9
Formulations Tested on Aluminum Substrate* for
Electric Vehicle Battery Cold Plate Assembly

| Material | 27 | 28 | 29 | 30 |
|---|---|---|---|---|
| HPR 2128 | 76 | 76 | 76 | 76 |
| R8200 | 19 | 19 | 19 | 19 |
| CT-762 | 1 | 1 | 1 | 1 |
| ST-E100 | 4 | | 2 | |
| MA75 | | 4 | 2 | |
| MLQ-PB2100 | | | | 4 |
| OLS, Control (psi) | 2396 | 2746 | 3561 | 3536 |
| OLS, 5 days in PRES 1 @ 90° C. (psi) | 2928 | 3369 | 3158 | 2984 |
| OLS, 14 days in PRES 1 @ 90° C. (psi) | 3120 | 2065 | 2479 | 2431 |
| OLS, 5 days in PRES DC @ 90° C. (psi) | 3298 | 2099 | 1869 | 1491 |
| OLS, 14 days in PRES DC @ 90° C. (psi) | 3129 | 1633 | 1514 | 1079 |

*Aluminum coupons with a thickness of 0.080 inch

1. An adhesive composition comprising:
i) unpolymerized cyclic olefin; and
ii) a ring opening metathesis polymerization catalyst or precatalyst thereof; and
iii) one or more adhesion promoter selected from the group consisting of polyolefin(s) comprising maleic anhydride or silicon-containing moieties; or a combination thereof.

2. The adhesive composition of claim 1 wherein the polyolefin(s) have an average anhydride equivalent weight ranging from 200 to 5000 g/mole per anhydride group.

3. The adhesive composition of claim 1 wherein the polyolefin(s) comprise alkene moieties.

4. The adhesive composition of claim 3 wherein the polyolefin(s) comprise polybutadiene.

5. The adhesive composition of claim 1 wherein the polyolefin(s) lack polystyrene blocks.

6. The adhesive composition of claim 1 wherein the adhesive composition further comprises one or more polymeric polyisocyanate(s) comprising oxygen atoms in the backbone.

7. The adhesive composition of claim 6 wherein the polymeric polyisocyanate(s) have an average equivalent weight ranging from 200 to 5000 g/mole per isocyanate group.

8. The adhesive composition of claim 6 wherein the polymeric polyisocyanate(s) comprise C2-C4 alkylene oxide repeat units.

9. The adhesive composition of claim 1 wherein the adhesion promoter has a molecular weight (Mn) of no greater than 10,000; 9,000; 8,000; 7,000; or 6,000 g/mole.

10. The adhesive composition of claim 1 wherein the adhesion promoter comprises at least one polymeric isocyanate comprising polyether moieties and at least one olefin polymer comprising maleic anhydride or silicon-containing moieties.

11. The adhesive composition of claim 1 wherein the unpolymerized cyclic olefin comprises moieties selected from cyclopentadiene, norbornene, and oligomers thereof.

12. The adhesive composition of claim 1 wherein the catalyst is a ruthenium or osmium metal carbene catalyst.

13. The adhesive composition of claim 1 wherein the adhesive composition after polymerization of the cyclic olefin exhibits an overlap shear value with steel, aluminum, copper, or polyamide of at least 500 (3.5 MPa) or 1000 psi (6.9 Mpa) at a crosshead speed of 0.05 inches/min.

14. The adhesive composition of claim 13 wherein the polyamide is nylon.

15. The adhesive composition of claim 1 wherein the adhesive composition after polymerization of the cyclic olefin exhibits an overlap shear value with polyether ether ketone (PEEK) or polyether imide (PEI) of at least 500 (3.5 Mpa) or 1000 psi (6.9 Mpa) at a crosshead speed of 2 inches/min.

16. The adhesive composition of claim 1 wherein the adhesive composition is a two-part adhesive composition wherein the catalyst is in a separate part than the unpolymerized cyclic olefin.

17. A method of bonding a substrate comprising
providing an adhesive composition according to claim 1;
applying the adhesive composition to a substrate; and
polymerizing the cyclic olefin at room temperature or by exposure to actinic radiation, heat, or a combination thereof.

18. An article comprising a first substrate adhered to a second substrate with an adhesive composition according to claim 1.

19-23. (canceled)

24. An article comprising a first polyamide substrate adhered to a second substrate with an adhesive composition according to claim 1.

25-28. (canceled)

29. An electric vehicle battery cold plate assembly comprising:
a top plate bonded to a bottom plate or battery tray with an adhesive composition comprising
i) unpolymerized cyclic olefin; and
ii) a ring opening metathesis polymerization catalyst or precatalyst thereof; and
iii) one or more adhesion promoter comprising at least one polymeric adhesion promoter comprising functional groups is selected from the group consisting of isocyanate, maleic anhydride, silicon-containing moieties, or a combination thereof.

30-33. (canceled)
